(19) United States
(12) Patent Application Publication
(10) Pub. No.: US 2024/0077413 A1
(43) Pub. Date: Mar. 7, 2024

(54) SINUSOIDAL LAMP DRIVER

(71) Applicant: trinamiX GMBH, Ludwigshafen am Rhein (DE)

(72) Inventors: Felix Berno MUELLER, Ludwigshafen am Rhein (DE); David KAESTEL, Ludwigshafen am Rhein (DE); Andre HORSAK, Ludwigshafen am Rhein (DE); Samiul ISLAM, Ludwigshafen am Rhein (DE); Sourabh KULKARNI, Ludwigshafen am Rhein (DE); Celal Mohan OEGUEN, Ludwigshafen am Rhein (DE)

(21) Appl. No.: 18/262,305

(22) PCT Filed: Feb. 10, 2022
(86) PCT No.: PCT/EP2022/053203

§ 371 Date: Jul. 20, 2023

(30) Foreign Application Priority Data
Feb. 11, 2021 (EP) 21156593.2

(51) Int. Cl. G01N 21/31; H05B 39/04

(52) U.S. Cl. CPC G01N 21/31; H05B 39/044

(57) ABSTRACT

A device is disclosed. The device includes
a. at least one radiation emitting element configured for emitting a modulated thermal radiation as a result of its temperature; where the radiation emitting element includes at least one incandescent lamp; and
b. at least one electronic circuit configured for applying a periodic time-dependent voltage to the radiation emitting element, wherein where the electronic circuit is configured for controlling one or more of an amplitude, a duty cycle and a frequency of the periodic time-dependent voltage, where a temperature of the radiation emitting element and a frequency of the modulated thermal radiation depend on the applied periodic time-dependent voltage controlled by the electronic circuit.

### FIELD OF THE INVENTION

The invention relates to a device comprising at least one radiation emitting element, a spectrometer device, a method for operating a device comprising at least one radiation emitting element and to various uses of the spectrometer device. Such devices and methods can, in general, be employed for various applications for example, for investigation or monitoring purposes, in particular, for infrared detection, heat detection, flame detection, fire detection, smoke detection, pollution monitoring, monitoring of industrial process, chemical process, food processing process or the like. However, further kinds of applications are possible.

### PRIOR ART

Applications such as spectroscopy require broad band radiation sources. Modern lamp technologies, e.g., LEDs and Lasers are narrow band radiators, viz., their emission spectrum is very narrow if not monochromatic. Technologies for achieving a broad emission spectrum in the visible range, which use fluorescent coatings applied to the semiconductor light source, e.g., white LED for general lighting, are limited for near infrared (NIR) range and nearly non-existing for mid infrared detection (MID). Thus, specifically in these ranges, thermal radiators, e.g., incandescent lamps, are employed, where an emission spectrum depends on their temperature. Furthermore, to remove noise sources, e.g., 1/f also known as flicker noise, or offsets, e.g., ambient light from the sun or artificial lighting, the light coming to a detector is modulated either by electrically modulating the light source or using optical chopper setups.

For light sources based on semiconductor technology, e.g., LED and laser, electrical modulation is very common and simple to achieve, since their bandwidths lay in kHz if not in MHz range.

For thermal radiators on the other hand options are rather limited. There are pulse operation modes, where voltage pulses with modulation of square waves are applied to an incandescent lamp. To limit current flowing through a filament, pulse width of a square wave may be kept small in the beginning, while the pulse width is increased with increasing temperature of the lamp. Control via Pulse-width modulation (PWM) can lead to electromagnetic compatibility (EMC) problems. PWM with steep edges can drastically reduce the life of the lamp. Also, infrared emitters based on a thin dielectric heating plate membrane containing a high-temperature stable metal are employed. For the production, thin film processes are performed with standard microelectromechanical systems (MEMS) processes and such MEMS-based IR emitters can be modulated with a good lifetime.

Despite the advantages achieved by the known devices and methods, various technical challenges remain. Opto-mechanical setups as the above-mentioned chopper may increase the cost of a spectrometer device, while reducing its lifespan. They generate a sound noise and more importantly, their mechanical stability cannot be guaranteed in a hand-held application, since they may wobble, and their rotation frequency may vary, which may have a negative effect on the measurement results. Thus, the electrical modulation of the light source should be preferred, specifically for hand-held applications.

Incandescent lamps are however generally hard to be electrically modulated. The temporal response of a thermal radiator is, compared to the semiconductor light sources very slow, viz., in the single- or two-digit Hz range. Furthermore, the thermal light sources feature a positive temperature coefficient (PTC), which means the resistance of the thermal radiator in cold condition (mostly equal to ambient temperature) is very low. Thus, during power-on, current flowing through the thermal radiator is high and leads to spontaneous heating, which breaks the light source, if it is not controlled.

For the above-mentioned MEMS-based IR emitters, a maximum achievable temperature on the heating membrane is <1000° C. Thus, their emission spectrum is suitable to only a limited extent for infrared spectroscopy. Furthermore, a large membrane has a larger heat capacity, which makes the temporal response of the light source slower. To achieve a higher bandwidth, the maximum operation temperature should be reduced further. Moreover, the price range of MEMS-based IR emitters is one order of magnitude if not two orders of magnitude higher than the price range of an incandescent lamp.

DE 10 2019 208748 A1 describes an electronic arrangement which includes a radiation source. A controlled voltage converter is configured to provide a lamp voltage for the radiation source for operating the radiation source in an ON state for a pulse duration, and to regulate the lamp volt-age such that a reference voltage at a feedback terminal of the voltage converter is maintained substantially constant. A voltage source is connected to the feedback terminal and configured to provide, via the feedback terminal for acting on the regulation of the voltage converter, a time-dependent control voltage having a predefined time profile. The voltage converter is configured to select a time profile for the lamp voltage as a function of the predefined time profile of the time-dependent control voltage such that a power of the radiation source deviates from a constant power value by no more than 25% during at least 90% of the pulse duration.

US 2007/278384 A1 describes a method and apparatus for driving a modulated radiation source. The method affects the power driving a light source in such as way so as to minimize the warm-up time of the source.

### Problem Addressed by the Invention

It is therefore an object of the present invention to provide devices and methods facing the above-mentioned technical challenges of known devices and methods. Specifically, it is an object of the present invention to provide low cost devices and methods for emitting electrically modulated thermal radiation with a good lifetime, in particular for mobile applications.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

In a first aspect of the present invention, a device is disclosed. The device comprises
a. at least one radiation emitting element configured for emitting a modulated thermal radiation as a result of its temperature, wherein the radiation emitting element comprises at least one incandescent lamp;
b. at least one electronic circuit configured for applying a periodic time-dependent voltage to the radiation emitting element, wherein the electronic circuit is configured for controlling one or more of an amplitude, a duty cycle and a frequency of the periodic time-dependent voltage, wherein a temperature of the radiation emitting element and a frequency of the modulated thermal radiation depend on the applied periodic time-dependent voltage controlled by the electronic circuit.

As used herein, the term “radiation” is a broad term and is to be given its ordinary and customary meaning to a person of ordinary skill in the art and is not to be limited to a special or customized meaning. The term specifically may refer, without limitation, to electromagnetic radiation in one or more of the visible spectral range, the ultraviolet spectral range and the infrared spectral range. Herein, the term “ultraviolet spectral range”, generally, refers to electromagnetic radiation having a wavelength of 1 nm to 380 nm, preferably of 100 nm to 380 nm. Further, in partial accordance with standard ISO-21348 in a valid version at the date of this document, the term “visible spectral range”, generally, refers to a spectral range of 380 nm to 760 nm. The term “infrared spectral range” is a broad term and is to be given its ordinary and customary meaning to a person of ordinary skill in the art and is not to be limited to a special or customized meaning. The term specifically may refer, without limitation, to electromagnetic radiation in the range of 760 nm to 1000 μm, wherein the range of 760 nm to 1.5 μm is usually denominated as “near infrared spectral range” (NIR) while the range from 1.5μ to 15 μm is denoted as “mid infrared spectral range” (MidIR) and the range from 15 μm to 1000 μm as “far infrared spectral range” (FIR). Preferably, radiation used for the typical purposes of the present invention is radiation in the infrared (IR) spectral range, more preferred, in the near infrared (NIR) and the mid infrared spectral range (MidIR), especially the radiation having a wavelength of 1 μm to 5 μm, preferably of 1 μm to 3 μm.

As further used herein, the term “emitting” is a broad term and is to be given its ordinary and customary meaning to a person of ordinary skill in the art and is not to be limited to a special or customized meaning. The term specifically may refer, without limitation, to an arbitrary process of generating and sending out radiation. As used herein, the term “radiation emitting element” is a broad term and is to be given its ordinary and customary meaning to a person of ordinary skill in the art and is not to be limited to a special or customized meaning. The term specifically may refer, without limitation, to an in principle arbitrary device configured for emitting radiation.

The radiation emitting element comprises at least one incandescent lamp. As used herein, the term “incandescent lamp” is a broad term and is to be given its ordinary and customary meaning to a person of ordinary skill in the art and is not to be limited to a special or customized meaning. The term specifically may refer, without limitation, to a light source based on a heated light emitting filament. The incandescent lamp may comprise at least one bulb having the at least one filament positioned inside. The filament may comprise at least one wire, specifically a coiled wire. The filament may comprise tungsten. The bulb may be a glass bulb filled by an inert gas. The inert gas, e.g., may comprise a combination of argon and nitrogen. When applying the periodic time-dependent voltage across the radiation emitting element, electric current flows through the filament and increases the temperature of the filament such that the filament emits thermal radiation. As an example, the incandescent lamp may be configured for emitting light in the infrared spectral range. The incandescent lamp may be or may comprise an infrared lamp. For example, a tungsten filament with a halogen filling may be used. However, other embodiments are possible such as fillings with xenon, argon gases.

The term “modulating” also is a broad term and is to be given its ordinary and customary meaning to a person of ordinary skill in the art and is not limited to a special or customized meaning. The term specifically may refer, without limitation, to the process of changing, specifically periodically changing, at least one property of light, specifically one or both of an intensity or a phase of the light. The modulation may be a full modulation from a maximum value to zero, or may be a partial modulation, from a maximum value to an intermediate value greater than zero. As used herein, the term “modulated radiation” is a broad term and is to be given its ordinary and customary meaning to a person of ordinary skill in the art and is not to be limited to a special or customized meaning. The term specifically may refer, without limitation, to radiation having at least one modified property such as an amplitude or a frequency.

As further used herein, the term “thermal radiation” is a broad term and is to be given its ordinary and customary meaning to a person of ordinary skill in the art and is not to be limited to a special or customized meaning. The term specifically may refer, without limitation, to electromagnetic radiation generated by thermal motion of particles in matter.

The term “electronic circuit” is a broad term and is to be given its ordinary and customary meaning to a person of ordinary skill in the art and is not to be limited to a special or customized meaning. The term specifically may refer, without limitation, to an assembly of at least two electronic components such as resistors, inductors, capacitors, diodes or transistors, which are at least partially interconnected through conductive elements such as wires or traces.

As used herein, the term “voltage” is a broad term and is to be given its ordinary and customary meaning to a person of ordinary skill in the art and is not to be limited to a special or customized meaning. The term specifically may refer, without limitation, to a difference in electrical potentials at two different points. If however only one point is indicated, the term voltage may refer to the electrical potential at this point measured against ground. In case it is referred to a voltage across a device, the term voltage may refer to the difference between electrical potentials at distal ends of the device. As used herein, the term “applying voltage” to the radiation emitting element, also denoted as applying the voltage across the radiation emitting element, is a broad term and is to be given its ordinary and customary meaning to a person of ordinary skill in the art and is not to be limited to a special or customized meaning. The term specifically may refer, without limitation, to generating a difference in electric potential between two points of the radiation emitting element. The device may comprise at least one voltage source for generating and applying the voltage across the radiation emitting element. As used herein, the term “voltage source” is a broad term and is to be given its ordinary and customary meaning to a person of ordinary skill in the art and is not to be limited to a special or customized meaning. The term specifically may refer, without limitation, to at last one arbitrary device configured for generating and/or providing the voltage. The voltage source may be a two-terminal device configured for maintaining a predetermined or pre-defined voltage.

As used herein, the term “periodic” is a broad term and is to be given its ordinary and customary meaning to a person of ordinary skill in the art and is not to be limited to a special or customized meaning. The term specifically may refer, without limitation, to a process repeating itself in regular and/or equal intervals. As used herein, the term “time-dependent voltage” is a broad term and is to be given its ordinary and customary meaning to a person of ordinary skill in the art and is not to be limited to a special or customized meaning. The term specifically may refer, without limitation, to the fact that the voltage U is or follows a function of time t, i.e. U(t). For example, the periodic time-dependent voltage may be sinusoidal or may be a square wave voltage.

The electronic circuit is configured for controlling one or more of an amplitude, a duty cycle and a frequency of the periodic time-dependent voltage. As used herein, the term “amplitude” is a broad term and is to be given its ordinary and customary meaning to a person of ordinary skill in the art and is not to be limited to a special or customized meaning. The term specifically may refer, without limitation, to a local and/or a global extremum, in particular a maximum or minimum, of the periodic time-dependent voltage. The term “duty cycle”, as used herein, is a broad term and is to be given its ordinary and customary meaning to a person of ordinary skill in the art and is not to be limited to a special or customized meaning. The term specifically may refer, without limitation, to a fraction of one period in which a signal or system is active. In particular, the duty cycle may be calculated as a ratio of a pulse duration divided by a period duration given the case of a periodic sequence of pulses. As further used herein, the term “frequency” is a broad term and is to be given its ordinary and customary meaning to a person of ordinary skill in the art and is not to be limited to a special or customized meaning. The term specifically may refer, without limitation, to a number of occurrences of a repeating event over time and/or may be defined as the reciprocal of the period duration.

As used herein, the term “controlling” of one or more of an amplitude, a duty cycle and a frequency of the periodic time-dependent voltage, is a broad term and is to be given its ordinary and customary meaning to a person of ordinary skill in the art and is not to be limited to a special or customized meaning. The term specifically may refer, without limitation, to an action of at least one of monitoring and/or setting and/or regulating of one or more of the amplitude, the duty cycle and the frequency of the periodic time-dependent voltage. The controlling of one or more of the amplitude, the duty cycle and the frequency of the periodic time-dependent voltage may comprise a setting a target amplitude, target duty cycle and/or target frequency. The controlling may comprise a maintaining of one or more the target amplitude, target duty cycle and/or target frequency.

The temperature of the radiation emitting element and the frequency of the modulated thermal radiation depend on the applied periodic time-dependent voltage controlled by the electronic circuit. As outlined above, when the electric current flows through the filament, the filament may be heated up to a temperature causing the filament to radiate thermal radiation. The applied periodic time-dependent voltage may cause the radiation emitting element to heat up, such as to a target temperature, which in turn causes the radiation emitting element to emit thermal radiation. Without to be bound by theory, the radiation emitting element may experience joule heating. The power of heating may be proportional to a product of the periodic time-dependent voltage applied to the radiation emitting element multiplied with the electric current running through the radiation emitting element. The electric current running through the radiation emitting element may be expressed via the resistance of the radiation emitting element using Ohm's law. In this respect, the radiation emitting element may be or may comprise a nearly pure resistive load with a power factor near to 1. The temperature of the radiation emitting element may cause a radiation with a frequency distribution according to Planck's law. Thus, a spectral radiance B of the radiation may generally be defined as function of a frequency v and a temperature T as follows:

$$B ( v , T ) = \frac{2 {hv}^{3}}{{c}^{2}} \frac{1}{{e}^{hv / ( kT )} - 1} ,$$

wherein h refers to the Planck's constant, c to the medium-dependent velocity of light and k to the Boltzmann constant. A maximum spectral radiance of the radiation emitting element may be located in the infrared spectral range.

The electronic circuit may be configured for controlling the periodic time-dependent voltage such that the applied periodic time-dependent voltage is unipolar and sinusoidal. As used herein, the term “unipolar” is a broad term and is to be given its ordinary and customary meaning to a person of ordinary skill in the art and is not to be limited to a special or customized meaning. The term specifically may refer, without limitation, to an exclusively one directional electric current. As an example, a unipolar voltage may always be greater than or equal to zero, but never negative, so that the flow direction of the electric current never turns around. Further, a unipolar voltage may be constant over time or may be non-constant over time as long as it does not switch sign. As used herein, the term “sinusoidal” is a broad term and is to be given its ordinary and customary meaning to a person of ordinary skill in the art and is not to be limited to a special or customized meaning. The term specifically may refer, without limitation, to a curve progression which can be represented by a sine wave with corresponding amplitude, frequency, phase and offset along the ordinate.

Without being bound by theory, applying a sinusoidal wave to a non-linear load may cause presence of harmonics and thus, distortion of the waveform. The harmonics may be overtones which are multiples, specifically whole number multiples, of the frequency of the voltage signal. A distorted periodic voltage waveform V(t) may be written as

$$V ( t ) = {V}_{0} + {\sum }_{h = 1}^{∞} {V}_{h} sin ( h ω t + {θ}_{h} )$$

wherein V₀ is a DC component voltage, voltages Vₕ the respective voltage at a harmonic h, t is the time and ω is the frequency and θₕ is the phase angle. The distortion of the waveform can be written as a single quantity/index, denoted as “Total Harmonic Distortion” (THD). THD is a known tool to identify how much of the distortion of a voltage or current is due to harmonics in the signal. A voltage or current that is purely sinusoidal has no harmonic distortion because it is a signal consisting of a single frequency. A voltage or current that is periodic but not purely sinusoidal will have higher frequency components in it contributing to the harmonic distortion of the signal. In general, the less that a periodic signal looks like a sine wave, the stronger the harmonic components are and the more harmonic distortion it will have.

The electronic circuit is configured for controlling the periodic time-dependent voltage such that a total harmonic distortion of the periodic time-dependent voltage is in a range from 0.01 to 0.2, preferably from 0.015 to 0.15, more preferably from 0.02 to 0.1. The total harmonic distortion THD of the sinusoidal voltage may be calculated as the quotient of the root-mean-square (RMS) values of the applied voltage with all of the harmonics filtered out wherein the total harmonic distortion of the sinusoidal voltage, calculated as the quotient of the RMS values of the applied voltage with all of the harmonics filtered out leaving just the fundamental frequency, denoted as V_{Applied,RMS,Fundemental}, and the RMS value of the applied voltage with the fundamental frequency filtered out leaving all of the harmonics, denoted V_{Applied,RMS without Fundemental}, as

$$THD = \frac{{V}_{Applied , RMS without Fundemental}}{{V}_{Applied , RMS Fundemental}} .$$

In power systems, lower THD implies lower peak currents, less heating and lower electromagnetic emissions. The total harmonic distortion of the modulated thermal radiation, also denoted as optical output of the radiation emitting element, ϕₑ due to its temperature T, may be calculated as the quotient of the root-means-square (RMS) values of the optical output with all of the harmonics filtered out leaving just the fundamental frequency, denoted as Φ_{e,RMS Fundemental}, and the RMS value of the optical output with the fundamental frequency filtered out leaving all of the harmonics, denoted as Φ_{e,RMS without Fundemental}, as

$$THD = \frac{{Φ}_{e , RMS without Fundemental}}{{Φ}_{e , RMS Fundemental}} .$$

The electronic circuit may be configured for controlling the periodic time-dependent voltage applied to the radiation emitting element such that a total harmonic distortion of an optical output of the radiation emitting element is in a range from 0.05 to 0.4, preferably from 0.07 to 0.3, more preferably from 0.1 to 0.25.

The electronic circuit may be configured for controlling the periodic time-dependent voltage in such a way that a resulting current through the radiation emitting element is also periodic time-dependent with a total harmonic distortion in a range from 0.01 to 0.2, preferably from 0.015 to 0.15, more preferably from 0.02 to 0.1.

The electronic circuit may comprise at least one evaluation unit configured for measuring a current flowing through the radiation emitting element. An information about a current state of the current may be used to configure the applied voltage.

The electronic circuit may comprise at least one variable output buck regulator.

As further used herein, the term “buck regulator”, is a broad term and is to be given its ordinary and customary meaning to a person of ordinary skill in the art and is not to be limited to a special or customized meaning. The term specifically may refer, without limitation, to a DC-DC converter which is configured for modifying at least one input voltage to at least one output voltage which is smaller than or equal to the input voltage. Above and in the following, DC refers to direct current. As used herein, the term “variable” is a broad term and is to be given its ordinary and customary meaning to a person of ordinary skill in the art and is not to be limited to a special or customized meaning. The term specifically may refer, without limitation, to an entity being changeable and/or modifiable and/or editable. As used herein, the term “variable output” is a broad term and is to be given its ordinary and customary meaning to a person of ordinary skill in the art and is not to be limited to a special or customized meaning. The term specifically may refer, without limitation, to passing on a variable physical quantity such as a voltage or a current. The physical quantity may have been an input and may have subsequently been modified before the modified physical quantity may be passed on as output. As an example, an input voltage may be modified, e.g. reduced, before passing it on as output voltage. As used herein, the term “variable output buck regulator” is a broad term and is to be given its ordinary and customary meaning to a person of ordinary skill in the art and is not to be limited to a special or customized meaning. The term specifically may refer, without limitation, to a buck regulator providing at least one variable output. As an example, the buck regulator may receive an input voltage, reduce the input voltage to a variable target voltage and provide the target voltage as output. Alternatively, the buck regulator may however also leave an input, e.g. a voltage and/or a current, unmodified and simply pass it on as output.

The electronic circuit may comprise at least one first input voltage source configured for applying the non-modulated supply voltage V_{supply} to the buck regulator. As used herein, the term “input voltage source” is a broad term and is to be given its ordinary and customary meaning to a person of ordinary skill in the art and is not to be limited to a special or customized meaning. The term specifically may refer, without limitation, to a voltage source, wherein the voltage generated or provided by the voltage source is used as an input for further devices or electronic elements. As further used herein, the term “supply voltage” is a broad term and is to be given its ordinary and customary meaning to a person of ordinary skill in the art and is not to be limited to a special or customized meaning. The term specifically may refer, without limitation, to a voltage used as an input in a device or electronic element, wherein the voltage may serve as power source for the device or electronic element. The supply voltage may be modified by the device or electronic element, wherein the power for this further modification may be supplied by the supply voltage. The supply voltage may be a DC voltage. The first input voltage source may be connected with an input of the buck regulator. The non-modulated supply voltage V_{Supply} may be used as an input for the variable output buck regulator.

The buck regulator may comprise at least one buck converter. The buck converter may comprise at least one of a controller, a switch, e.g. a transistor, and a diode. The buck converter may comprise at least one voltage input. The buck regulator may be configured for receiving at least one input voltage, in particular the non-modulated supply voltage V_{supply}. Specifically, a constant DC supply voltage may be applied to the voltage input of the buck converter. The buck converter may comprise at least one of an inductor connection and an output feedback connection. The inductor connection may be configured for connecting the buck converter to at least one inductor of the buck regulator. The inductor may be connected to at least one capacitor of the buck regulator. The capacitor may be grounded. In the buck converter, at least one controller may be configured for regularly switching at least one switch on and off, typically several thousand up to some million times per second, in order to modify at least one input voltage. Further, at least one diode of the buck converter may be configured for blocking the input current, thereby forcing it to run through at least one inductor of the buck regulator to at least one capacitor of the buck regulator, when the switch is switched on. The inductor may be configured for storing electrical energy during the time when the switch is switched on. The capacitor may be configured for storing an electrical charge during the time when the switch is switched on. The diode may further be configured for letting an electric current induced by the inductor through, when the switch is switched off, wherein the electric current induced by the inductor is fed by the electric charge from the capacitor.

The buck regulator may comprise at least one resistor network. As used herein, the term “network” is a broad term and is to be given its ordinary and customary meaning to a person of ordinary skill in the art and is not to be limited to a special or customized meaning. The term specifically may refer, without limitation, to a group of at least partially interconnected components. As further used herein, the term “resistor” is a broad term and is to be given its ordinary and customary meaning to a person of ordinary skill in the art and is not to be limited to a special or customized meaning. The term specifically may refer, without limitation, to an electrical device configured for implementing electrical resistance. The resistance may be defined as a ratio of a voltage across a device divided by an electric current going through the device. As used herein, the term “resistor network” is a broad term and is to be given its ordinary and customary meaning to a person of ordinary skill in the art and is not to be limited to a special or customized meaning. The term specifically may refer, without limitation, to a network comprising at least one resistor. The resistor network may for instance further comprise wires and/or traces for at least partially connecting resistors and/or further components of the resistor network with each other. For example, the resistor network may comprise at least one first resistor R₁ connected in parallel with the capacitor. The resistor network may comprise further resistors.

The electronic circuit may comprise at least one variable electronic component configured for modulating an output of the variable buck regulator which may be applied to the radiation emitting element as an applied voltage V_{Applied}. As used herein, the term “variable electronic component” is a broad term and is to be given its ordinary and customary meaning to a person of ordinary skill in the art and is not to be limited to a special or customized meaning. The term specifically may refer, without limitation, to an electronic component with variable physical properties. The variable electronic component may be or may comprise a variable resistance and/or a variable voltage source.

The variable electronic component may comprise the at least one variable voltage source, in particular a modulated voltage source. The variable voltage source may be configured for applying a periodic time-dependent input voltage V_{Input} to the resistor network thereby transforming the output of the variable buck regulator into a periodic time-dependent voltage. The periodic time-dependent voltage may be applied to the radiation emitting element as the applied voltage V_{Applied}. As outlined above, the buck regulator with variable output may be connected to the resistor network. A constant DC supply voltage may be applied to the buck regulator. The variable voltage source may be used as a second input voltage source, which is configured for generating a modulated voltage also connected to the resistor network in such a way that the output of the buck regulator, which is applied to the radiation emitting element, is also a modulated voltage. For example, a Digital-Analog-Converter (DAC) output of a microcontroller may be used as variable voltage source. In this embodiment, the resistor network may comprise three resistors, denoted R₁, R₂ and R₃. The first resistor R₁ may be connected in parallel with the capacitor. The resistor R₁ may be connected in series to the resistor R₂. The resistor R₂ may be grounded. The resistors R₁ and R₂ may form a voltage divider. The resistor R₁ may be connected to the resistor R₃, in particular an output of the voltage divider may be connected to the resistor R₃. The resistor R₃ may be connected to the variable voltage source. The output of the variable voltage source may be summed into the output feedback connection.

The variable electronic component may comprise the at least one variable resistor. The variable resistor may be configured for changing its resistance R_{Variable} periodically as a function of time thereby transforming the output of the variable buck regulator into a periodic time-dependent voltage, which may be applied to the radiation emitting element as the applied voltage V_{Applied}. As used herein, the term “variable resistor” is a broad term and is to be given its ordinary and customary meaning to a person of ordinary skill in the art and is not to be limited to a special or customized meaning. The term specifically may refer, without limitation, to a resistor with a variable resistance, specifically a resistance which is continuously variable over time. The variable resistor may be configured to vary its resistance over a continuous resistance range. The variable resistor may be configured to vary its resistance between a plurality of discrete resistance values. The variable resistor may cause a variable voltage drop in the electronic circuit. As an example, a constant output voltage of the variable output buck regulator may experience a variable voltage drop over the variable resistor over time resulting in a periodic time-dependent voltage. The variable resistor may be grounded. The variable resistor may be connected in series to at least one further resistor of the resistor network, specifically the resistor R₂, and to the output feedback connection of the buck converter.

The variable resistor may comprise a digital potentiometer. As used herein, the term “potentiometer” is a broad term and is to be given its ordinary and customary meaning to a person of ordinary skill in the art and is not to be limited to a special or customized meaning. The term specifically may refer, without limitation, to a three-terminal resistor with a sliding or rotating contact forming an adjustable voltage divider. Consequently, as used herein, the term “digital potentiometer” is a broad term and is to be given its ordinary and customary meaning to a person of ordinary skill in the art and is not to be limited to a special or customized meaning. The term specifically may refer, without limitation, to a digitally-controlled electronic component which mimics the analog functions of a potentiometer.

In a further aspect of the present invention, a spectrometer device is disclosed. The spectrometer device comprises
i. at least one device according to the present invention such as in any one of the embodiments disclosed above or in further detail below, wherein the device is configured for illuminating at least one measurement object;
ii. at least one filter element configured to separate at least one incident light beam remitted by the measurement object into a spectrum of constituent wavelength;
iii. at least one sensor element having a matrix of optical sensors, the optical sensors each having a light-sensitive area, wherein each optical sensor is configured for generating at least one sensor signal in response to an illumination of the light-sensitive area; and
iv. at least one evaluation device configured for determining at least one item of information related to the spectrum by evaluating the sensor signals.

As indicated, the spectrometer device comprises at least one device according to the present invention. Thus, with respect to definitions and embodiments of the device reference is made to the description of the device. The device is configured for illuminating at least one measurement object.

As used herein, the term “spectrometer device” is a broad term and is to be given its ordinary and customary meaning to a person of ordinary skill in the art and is not to be limited to a special or customized meaning. The term specifically may refer, without limitation, to an apparatus which is capable of recording signal intensity with respect to the corresponding wavelength of a spectrum or a partition thereof, such as a wavelength interval, wherein the signal intensity may, preferably, be provided as an electrical signal which may be used for further evaluation. As further used herein, the term “object” is a broad term and is to be given its ordinary and customary meaning to a person of ordinary skill in the art and is not to be limited to a special or customized meaning. The term specifically may refer, without limitation, to a sample or an arbitrary body, chosen from a living object and a non-living object. Thus, as an example, the at least one object may comprise one or more articles and/or one or more parts of an article, wherein the at least one article or the at least one part thereof may comprise at least one component which may provide a spectrum suitable for investigations. Additionally or alternatively, the object may be or may comprise one or more living beings and/or one or more parts thereof, such as one or more body parts of a human being, e.g. a user, and/or an animal. Consequently, as used herein, the term “measurement object” is a broad term and is to be given its ordinary and customary meaning to a person of ordinary skill in the art and is not to be limited to a special or customized meaning. The term specifically may refer, without limitation, to an object which is to be measured, e.g. for which a spectrum is to be recorded, wherein the object has in principle arbitrary properties, e.g. arbitrary optical properties or an arbitrary shape.

The spectrometer device comprises at least one filter element. The filter element is configured to separate at least one incident light beam remitted by the measurement object into a spectrum of constituent wavelength. As used herein, the term “filter element” is a broad term and is to be given its ordinary and customary meaning to a person of ordinary skill in the art and is not to be limited to a special or customized meaning. The term specifically may refer, without limitation, to an optical element which is adapted for separating incident light into the spectrum of constituent wavelength signals. For example, the filter element may be or may comprise at least one prism. For example, the filter element may be and/or may comprise at least one optical filter such as a length variable filter, i.e. an optical filter which comprises a plurality of filters, preferably a plurality of interference filters, which may, in particular, be provided in a continuous arrangement of the filters. Herein, each of the filters may form a bandpass with a variable center wavelength for each spatial position on the filter, preferably continuously, along a single dimension, which is, usually, denoted by the term “length”, on a receiving surface of the length variable filter. In a preferred example, the variable center wavelength may be a linear function of the spatial position on the filter, in which case the length variable filter is usually referred to as a “linearly variable filter” or by its abbreviation “LVF”. However, other kinds of functions may be applicable to the relationship between the variable center wavelength and the spatial position on the filter. Herein, the filters may be located on a transparent substrate which may, in particular, comprise at least one material that may show a high degree of optical transparency within in the visual and/or infrared (IR) spectral range, especially, within the near-infrared (NIR) spectral range as described below in more detail, whereby varying spectral properties, especially continuously varying spectral properties, of the filter along length of the filter may be achieved. In particular, the filter element may be a wedge filter that may be adapted to carry at least one response coating on a transparent substrate, wherein the response coating may exhibit a spatially variable property, in particular, a spatially variable thickness. However, other kinds of length variable filters which may comprise other materials or which may exhibit a further spatially variable property may also be feasible. At a normal angle of incidence of an incident light beam, each of the filters as comprised by the length variable filter may have a bandpass width that may amount to a fraction of the center wavelength, typically to a few percent, of the particular filter. By way of example, for a length variable filter having a wavelength range from 1400 to 1700 nm and a bandpass width of 1%, the bandpass width at the normal incidence angle might vary from 14 nm to 17 nm. However, other examples may also be feasible. As a result of this particular setup of the length variable filter, only incident light having a wavelength which may, within a tolerance indicated by the bandpass width, equal the center wavelength being assigned to a particular spatial position on the filter is able to pass through the length variable filter at the particular spatial position. Thus, a “transmitting wavelength” which may be equal to the center wavelength ±½ of the bandpass width may be defined for each spatial position on the length variable filter. In other words, all light which may not pass through the length variable filter at the transmitting wavelength may be absorbed or, mostly, reflected by the receiving surface of the length variable filter. As a result, the length variable filter has a varying transmittance which may enable it for separating the incident light into a spectrum.

As used herein, the term “light beam” is a broad term and is to be given its ordinary and customary meaning to a person of ordinary skill in the art and is not to be limited to a special or customized meaning. The term specifically may refer, without limitation, to a directional projection of radiation. As further used herein, the term “spectrum” is a broad term and is to be given its ordinary and customary meaning to a person of ordinary skill in the art and is not to be limited to a special or customized meaning. The term specifically may refer, without limitation, to an electromagnetic spectrum or wavelength spectrum. Specifically, the spectrum may be a partition of the visual spectral range and/or of the infrared (IR) spectral range, especially of the near-infrared (NIR) spectral range. Herein, each part of the spectrum may be constituted by an optical signal defined by a signal wavelength and a corresponding signal intensity.

The spectrometer device comprises at least one sensor element having a matrix of optical sensors. The optical sensors each have a light-sensitive area. Each optical sensor is configured for generating at least one sensor signal in response to an illumination of the light-sensitive area. As used herein, the term “optical sensor” is a broad term and is to be given its ordinary and customary meaning to a person of ordinary skill in the art and is not to be limited to a special or customized meaning. The term specifically may refer, without limitation, to a light-sensitive device for detecting a light beam, such as for detecting an illumination and/or a light spot generated by at least one light beam.

As further used herein, the term “light-sensitive area” is a broad term and is to be given its ordinary and customary meaning to a person of ordinary skill in the art and is not to be limited to a special or customized meaning. The term specifically may refer, without limitation, to an area of the optical sensor which may be illuminated externally, by the at least one light beam, in response to which illumination at least one sensor signal is generated. The light-sensitive area may specifically be located on a surface of the respective optical sensor. Other embodiments, however, are feasible. Consequently, as used herein, the term “the optical sensors each having at least one light sensitive area” is a broad term and is to be given its ordinary and customary meaning to a person of ordinary skill in the art and is not to be limited to a special or customized meaning. The term specifically may refer, without limitation, to configurations with a plurality of single optical sensors each having one light sensitive area and to configurations with one combined optical sensor having a plurality of light sensitive areas.

The optical sensor may comprise a light-sensitive device configured to generate one output signal. In case the spectrometer device comprises a plurality of optical sensors, each optical sensor may be embodied such that precisely one light-sensitive area is present in the respective optical sensor, such as by providing precisely one light-sensitive area which may be illuminated, in response to which illumination precisely one uniform sensor signal is created for the whole optical sensor. Thus, each optical sensor may be a single area optical sensor. The use of the single area optical sensors, however, renders the setup of the detector specifically simple and efficient. Thus, as an example, commercially available photo-sensors, such as commercially available silicon photodiodes, each having precisely one sensitive area, may be used in the setup. Other embodiments, however, are feasible. The optical sensors may be part of or constitute a pixelated optical device. For example, the optical sensor may be and/or may comprise at least one CCD and/or CMOS device. As an example, the optical sensors may be part of or constitute at least one CCD and/or CMOS device having a matrix of pixels, each pixel forming a light-sensitive area.

The optical sensors specifically may be or may comprise at least one photodetector, preferably inorganic photodetectors, more preferably inorganic semiconductor photodetectors, most preferably silicon photodetectors. Specifically, the optical sensors may be sensitive in the infrared spectral range. All pixels of the matrix or at least a group of the optical sensors of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensors may be or may comprise at least one inorganic photodiode which is sensitive in the infrared spectral range, preferably in the range of 700 nm to 3.0 micrometers. Specifically, the optical sensors may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX GmbH, D-67056 Ludwigshafen am Rhein, Germany. Thus, as an example, the optical sensors may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensors may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensors may comprise at least one photoconductive sensor such as a PbS or PbSe sensor, a bolometer, preferably a bolometer selected from the group consisting of a VO bolometer and an amorphous Si bolometer.

The matrix may be composed of independent pixels such as of independent optical sensors. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip. Thus, generally, the optical sensor may be and/or may comprise at least one CCD and/or CMOS device and/or the optical sensors of the detector may form a sensor array or may be part of a sensor array, such as the above-mentioned matrix. Thus, as an example, the optical sensors may comprise and/or constitute an array of pixels, such as a rectangular array, having m rows and n columns, with m, n, independently, being positive integers. For example, the sensor element may comprise at least two optical sensors arranged in a row and or column such as a bi-cell. For example, the sensor element may a quadrant diode system comprising a 2×2 matrix of optical sensors. For example, more than one column and more than one row is given, i.e. n>1, m>1. Thus, as an example, n may be 2 to 16 or higher and m may be 2 to 16 or higher. Preferably, the ratio of the number of rows and the number of columns is close to 1. As an example, n and m may be selected such that 0.3≤m/n≤3, such as by choosing m/n=1:1, 4:3, 16:9 or similar. As an example, the array may be a square array, having an equal number of rows and columns, such as by choosing m=2, n=2 or m=3, n=3 or the like.

The matrix specifically may be a rectangular matrix having at least one row, preferably a plurality of rows, and a plurality of columns. As an example, the rows and columns may be oriented essentially perpendicular. As used herein, the term “essentially perpendicular” refers to the condition of a perpendicular orientation, with a tolerance of e.g. ±20° or less, preferably a tolerance of ±10° or less, more preferably a tolerance of ±5° or less. Similarly, the term “essentially parallel” refers to the condition of a parallel orientation, with a tolerance of e.g. ±20° or less, preferably a tolerance of ±10° or less, more preferably a tolerance of ±5° or less. Thus, as an example, tolerances of less than 2020 , specifically less than 10° or even less than 520 , may be acceptable. In order to provide a wide range of view, the matrix specifically may have at least 10 rows, preferably at least 500 rows, more preferably at least 1000 rows. Similarly, the matrix may have at least 10 columns, preferably at least 500 columns, more preferably at least 1000 columns. The matrix may comprise at least 50 optical sensors, preferably at least 100000 optical sensors, more preferably at least 5000000 optical sensors. The matrix may comprise a number of pixels in a multi-mega pixel range. Other embodiments, however, are feasible. Thus, in setups in which an axial rotational symmetry is to be expected, circular arrangements or concentric arrangements of the optical sensors of the matrix, which may also be referred to as pixels, may be preferred.

Preferably, the light sensitive area may be oriented essentially perpendicular to an optical axis of the spectrometer device. The optical axis may be a straight optical axis or may be bent or even split, such as by using one or more deflection elements and/or by using one or more beam splitters, wherein the essentially perpendicular orientation, in the latter cases, may refer to the local optical axis in the respective branch or beam path of the optical setup.

As further used herein, the term “sensor signal” is a broad term and is to be given its ordinary and customary meaning to a person of ordinary skill in the art and is not to be limited to a special or customized meaning. The term specifically may refer, without limitation, to a signal generated by the optical sensor and/or at least one pixel of the optical sensor in response to illumination. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like.

The spectrometer device comprises at least one evaluation device configured for determining at least one item of information related to the spectrum by evaluating the sensor signals. As further used herein, the term “evaluation device” is a broad term and is to be given its ordinary and customary meaning to a person of ordinary skill in the art and is not to be limited to a special or customized meaning. The term specifically may refer, without limitation, to an arbitrary device adapted to perform the named operation, preferably by using at least one data processing device and, more preferably, by using at least one processor and/or at least one application-specific integrated circuit. Thus, as an example, the at least one evaluation device may comprise at least one data processing device having a software code stored thereon comprising a number of computer commands. The evaluation device may provide one or more hardware elements for performing one or more of the named operations and/or may provide one or more processors with software running thereon for performing one or more of the named operations. As an example, the evaluation device may comprise one or more programmable devices such as one or more computers, application-specific integrated circuits (ASICs), Digital Signal Processors (DSPs), or Field Programmable Gate Arrays (FPGAs) which are configured to perform the evaluation. Additionally or alternatively, however, the evaluation device may also fully or partially be embodied by hardware. The at least one item of information may, for example, be provided electronically, visually, acoustically or in any arbitrary combination thereof. Further, the at least one item of information may be stored in a data storage device of the spectrometer device or of a separate storage device and/or may be provided via at least one interface, such as a wireless interface and/or a wire-bound interface.

In a further aspect of the present invention, a method for operating a device comprising at least one radiation emitting element according to any one of the embodiments disclosed above or in further detail below, is proposed. The method comprises the following steps:
I. applying at least one periodic time-dependent voltage to at least one of the radiation emitting elements;
II. controlling one or more of the amplitude, the duty cycle and the frequency of the periodic time-dependent voltage with at least one of the electronic circuits.

The method steps may be performed in the given order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion. For further definitions and embodiments of the method it may be referred to the definitions and embodiments of the device comprising at least one radiation emitting element.

Further disclosed and proposed herein is a computer program including computer-executable instructions for performing the method according to the present invention in one or more of the embodiments enclosed herein when the program is executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

In a further aspect of the present invention, a use of a spectrometer device according to any one of the embodiments disclosed above or in further detail below referring to a spectrometer device is proposed, for a purpose of use selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application.

The devices and methods according to the present invention may provide a large number of advantages over known methods, stations and systems. In particular, the present invention allows to provide a radiation emitting element with maximum achievable operating temperature for NIR spectroscopy. The electrical circuit driving the radiation emitting element may allow a high modulation depth specifically above 50%, at a high frequency, specifically above 10 Hz, together with a high operating temperature, specifically above 2000 K, and a good lifespan, specifically above 1M pulses, compared to MEMS-based IR emitters.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. As further used herein, in most cases, when referring to the respective feature or element, the expressions “at least one” or “one or more” are not repeated, non-withstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

Overall, in the context of the present invention, the following embodiments are regarded as preferred:

Embodiment 1. A device comprising
a. at least one radiation emitting element configured for emitting a modulated thermal radiation as a result of its temperature, wherein the radiation emitting element comprises at least one incandescent lamp;
b. at least one electronic circuit configured for applying a periodic time-dependent voltage to the radiation emitting element, wherein the electronic circuit is configured for controlling one or more of an amplitude, a duty cycle and a frequency of the periodic time-dependent voltage, wherein a temperature of the radiation emitting element and a frequency of the modulated thermal radiation depend on the applied periodic time-dependent voltage controlled by the electronic circuit.

Embodiment 2. The device according to the preceding embodiment, wherein the electronic circuit is configured for controlling the periodic time-dependent voltage such that the applied periodic time-dependent voltage is unipolar and sinusoidal.

Embodiment 3. The device according to any one of the preceding embodiments, wherein the electronic circuit is configured for controlling the periodic time-dependent voltage such that a total harmonic distortion of the periodic time-dependent voltage is in a range from 0.01 to 0.2, preferably from 0.015 to 0.15, more preferably from 0.02 to 0.1.

Embodiment 4. The device according to any one of the preceding embodiments, wherein the electronic circuit is configured for controlling the periodic time-dependent voltage in such a way that a resulting current through the radiation emitting element is also periodic time-dependent with a total harmonic distortion in a range from 0.01 to 0.2, preferably from 0.015 to 0.15, more preferably from 0.02 to 0.1.

Embodiment 5. The device according to any of the preceding embodiments, wherein the electronic circuit comprises at least one evaluation unit configured for measuring a current flowing through the radiation emitting element, wherein an information about a current state of the current is used to configure the applied voltage.

Embodiment 6. The device according to any one of the preceding embodiments, wherein the electronic circuit is configured for controlling the periodic time-dependent voltage applied to the radiation emitting element such that a total harmonic distortion of an optical output of the radiation emitting element is in a range from 0.05 to 0.4, preferably from 0.07 to 0.3, more preferably from 0.1 to 0.25.

Embodiment 7. The device according to any one of the preceding embodiments, wherein the electronic circuit comprises at least one variable output buck regulator, wherein the buck regulator comprises at least one resistor network.

Embodiment 8. The device according to the preceding embodiment, wherein the electronic circuit comprises at least one first input voltage source configured for applying a non-modulated supply voltage V_{Supply} to the buck regulator.

Embodiment 9. The device according to any one of the two preceding embodiments, wherein the electronic circuit comprises at least one variable electronic component configured for modulating an output of the variable buck regulator which is applied to the radiation emitting element as an applied voltage V_{Applied}.

Embodiment 10. The device according to the preceding embodiment, wherein the variable electronic component comprises at least one variable voltage source, wherein the variable voltage source is configured for applying a periodic time-dependent input voltage V_{Input} to the resistor network thereby transforming the output of the variable buck regulator into a periodical time-dependent voltage, which is applied to the radiation emitting element as the applied voltage V_{Applied}.

Embodiment 11. The device according to the preceding embodiment, wherein the variable voltage source comprises a Digital-Analog-Converter (DAC).

Embodiment 12. The device according to embodiment 9, wherein the variable electronic component comprises at least one variable resistor, wherein the variable resistor is configured for changing its resistance R_{Variable} periodically as a function of time thereby transforming the output of the variable buck regulator into a periodic time-dependent voltage, which is applied to the radiation emitting element as the applied voltage V_{Applied}.

Embodiment 13. The device according to the preceding embodiment, wherein the variable resistor comprises a digital potentiometer.

Embodiment 14. A spectrometer device comprising
i. at least one device according to any one of the preceding embodiments, wherein the device is configured for illuminating at least one measurement object;
ii. at least one filter element configured to separate at least one incident light beam remitted by the measurement object into a spectrum of constituent wavelength;
iii. at least one sensor element having a matrix of optical sensors, the optical sensors each having a light-sensitive area, wherein each optical sensor is configured for generating at least one sensor signal in response to an illumination of the light-sensitive area; and
iv. at least one evaluation device configured for determining at least one item of information related to the spectrum by evaluating the sensor signals.

Embodiment 15. A method for operating a device comprising at least one radiation emitting element according to any one of embodiments 1 to 14, the method comprising the following steps:
I. applying at least one periodic time-dependent voltage to at least one of the radiation emitting elements;
II. controlling one or more of the amplitude, the duty cycle and the frequency of the periodic time-dependent voltage with at least one of the electronic circuits.

Embodiment 16. A non-transient computer-readable medium including instructions that, when executed by one or more processors, cause the one or more processors to perform the method according to the preceding embodiment.

Embodiment 17. Use of a spectrometer device according to any one of the preceding embodiments referring to a spectrometer device for a purpose of use, selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; a food analysis application.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an exemplary embodiment of a device according to the present invention comprising at least one radiation emitting element;

FIGS. 2A-2C show experimental results;

FIG. 3 shows a further exemplary embodiment of the device according to the present invention;

FIG. 4 shows an exemplary embodiment of a spectrometer device according to the present invention;

FIG. 5 shows a flow chart of an embodiment of a method for operation a device according to the present invention.

### DETAILED DESCRIPTION OF THE EMBODIMENTS

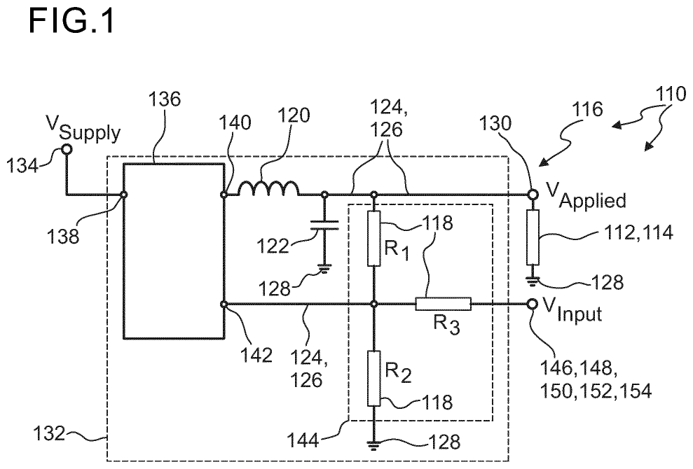

FIG. 1 shows an exemplary embodiment of an equivalent circuit of a device 110 according to the present invention comprising at least one radiation emitting element 112 for emitting a modulated thermal radiation as a result of its temperature. The modulated thermal radiation may be radiation having at least one modified property such as an amplitude or a frequency. The modulated thermal radiation may be electromagnetic radiation in one or more of the visible spectral range, the ultraviolet spectral range and the infrared spectral range. Preferably, radiation used for the typical purposes of the present invention is radiation in the infrared (IR) spectral range, more preferred, in the near infrared (NIR) and the mid infrared spectral range (MidIR), especially the radiation having a wavelength of 1 μm to 5 μm, preferably of 1 μm to 3 μm.

The radiation emitting element 112 comprises at least one incandescent lamp 114. The incandescent lamp 114 may be a light source based on a heated light emitting filament. The incandescent lamp 114 may comprise at least one bulb having the at least one filament positioned inside. The filament may comprise at least one wire, specifically a coiled wire. The filament may comprise tungsten. The bulb may be a glass bulb filled by an inert gas. The inert gas, e.g., may comprise a combination of argon and nitrogen. When applying the periodic time-dependent voltage across the radiation emitting element 112, electric current flows through the filament and increases the temperature of the filament such that the filament emits thermal radiation. As an example, the incandescent lamp 114 may be configured for emitting light in the infrared spectral range. The incandescent lamp 114 may be or may comprise an infrared lamp. For example, a tungsten filament with a halogen filling may be used. However, other embodiments are possible such as fillings with xenon, argon gases.

As shown in FIG. 1, the device 110 comprises at least one electronic circuit 116 configured for applying a periodic time-dependent voltage to the radiation emitting element 112. For example, the periodic time-dependent voltage may be sinusoidal or may be a square wave voltage.

The electronic circuit 116 is configured for controlling one or more of an amplitude, a duty cycle and a frequency of the periodic time-dependent voltage. The amplitude may be a local and/or a global extremum, in particular a maximum or minimum, of the periodic time-dependent voltage. The duty cycle may be a fraction of one period in which a signal or system is active. In particular, the duty cycle may be calculated as a ratio of a pulse duration divided by a period duration given the case of a periodic sequence of pulses. The frequency may be a number of occurrences of a repeating event over time and/or may be defined as the reciprocal of the period duration. The controlling of one or more of an amplitude, a duty cycle and a frequency of the periodic time-dependent voltage may be an action of at least one of monitoring and/or setting and/or regulating of one or more of the amplitude, the duty cycle and the frequency of the periodic time-dependent voltage. The controlling of one or more of the amplitude, the duty cycle and the frequency of the periodic time-dependent voltage may comprise a setting a target amplitude, target duty cycle and/or target frequency. The controlling may comprise a maintaining of one or more the target amplitude, target duty cycle and/or target frequency. A temperature of the radiation emitting element 112 and a frequency of the modulated thermal radiation depend on the applied periodic time-dependent voltage controlled by the electronic circuit 116.

The electronic circuit 116 may comprise at least one variable output buck regulator 132. The buck regulator 132 may be a DC-DC converter which is configured for modifying at least one input voltage to at least one output voltage which is smaller than or equal to the input voltage. The variable output may be a variable physical quantity such as a voltage or a current. The physical quantity may have been an input and may have subsequently been modified before the modified physical quantity may be passed on as output. As an example, an input voltage may be modified, e.g. reduced, before passing it on as output voltage. Thus, the buck regulator 132 may receive an input voltage, reduce the input voltage to a variable target voltage and provide the target voltage as output. Alternatively, the buck regulator 132 may however also leave an input, e.g. a voltage and/or a current, unmodified and simply pass it on as output.

The buck regulator 132 may comprise at least one buck converter 136. The buck converter 136 may comprise at least one of a controller, a switch, e.g. a transistor, and a diode. The buck converter 136 may comprise at least one voltage input 138. The buck converter 136 may comprise at least one of an inductor connection 140 and an output feedback connection 142. The inductor connection 140 may be configured for connecting the buck converter 136 to at least one inductor 120 of the buck regulator 132. The inductor 120 may be connected to at least one capacitor 122 of the buck regulator 132. The capacitor 122 may be grounded. In the buck converter 136, at least one controller may be configured for regularly switching at least one switch on and off, typically several thousand up to some million times per second, in order to modify at least one input voltage. Further, at least one diode of the buck converter 136 may be configured for blocking the input current, thereby forcing it to run through at least one inductor 120 of the buck regulator 132 to at least one capacitor 122 of the buck regulator 132, when the switch is switched on. The inductor 120 may be configured for storing electrical energy during the time when the switch is switched on. The capacitor 122 may be configured for storing an electrical charge during the time when the switch is switched on. The diode may further be configured for letting an electric current induced by the inductor 120 through, when the switch is switched off, wherein the electric current induced by the inductor 120 is fed by the electric charge from the capacitor 122.

The buck regulator 132, in particular the buck converter 136, may be configured for receiving at least one input voltage, in particular a non-modulated supply voltage V_{supply}. As indicated in FIG. 1, the electronic circuit 116 may comprise at least one first input voltage source 134 configured for applying the non-modulated supply voltage V_{Supply} to the buck regulator 132. The first input voltage source 134 may be connected with an input of the buck regulator 132 configured for receiving the at least one supply voltage, in particular the non-modulated supply voltage V_{supply}. In particular, a constant DC supply voltage may be applied to the voltage input 138 of the buck converter 136.

The buck regulator 132 may comprise at least one resistor network 144. The resistor network 144 may be a network comprising at least one resistor 118. The resistor network 144 may for instance further comprise wires 124 and/or traces 126 for at least partially connecting resistors 118 and/or further components of the resistor network 144 with each other. For example, in the embodiment of FIG. 1, the resistor network 144 may comprise three resistors, denoted R₁, R₂ and R₃. The first resistor R₁ may be connected in parallel with the capacitor 122. The resistor R₁ may be connected in series to the resistor R₂. The resistor R₂ may be grounded. The resistors R₁ and R₂ may form a voltage divider. The resistor R₁ may be connected to the resistor R₃, in particular an output of the voltage divider may be connected to the resistor R₃.

The electronic circuit 116 may comprise at least one variable electronic component 146 configured for modulating an output of the variable buck regulator 132 which may be applied to the radiation emitting element 112 as an applied voltage V_{Applied}. The variable electronic component 146 may be an electronic component with variable physical properties. The variable electronic component 146 may be or may comprise a variable resistance and/or a variable voltage source.

In the embodiment of FIG. 1, the variable electronic component 146 may be or may comprise a variable voltage source 148, in particular a modulated voltage source 150. The variable voltage source 148 may be configured for applying a periodic time-dependent input voltage V_{Input} to the resistor network 144 thereby transforming the output of the variable buck regulator 132 into a periodic time-dependent voltage. The resistor R₃ may be connected to the variable voltage source 148. The variable voltage source 148 may be used as a second input voltage source 152, which is configured for generating a modulated voltage also connected to the resistor network 144 in such a way that the output of the buck regulator 132, which is applied to the radiation emitting element 112, is also a modulated voltage. For example, a Digital-Analog-Converter (DAC) output 154 of a microcontroller may be used as variable voltage source 148. The output of the variable voltage source 148 may be summed into the output feedback connection 142.

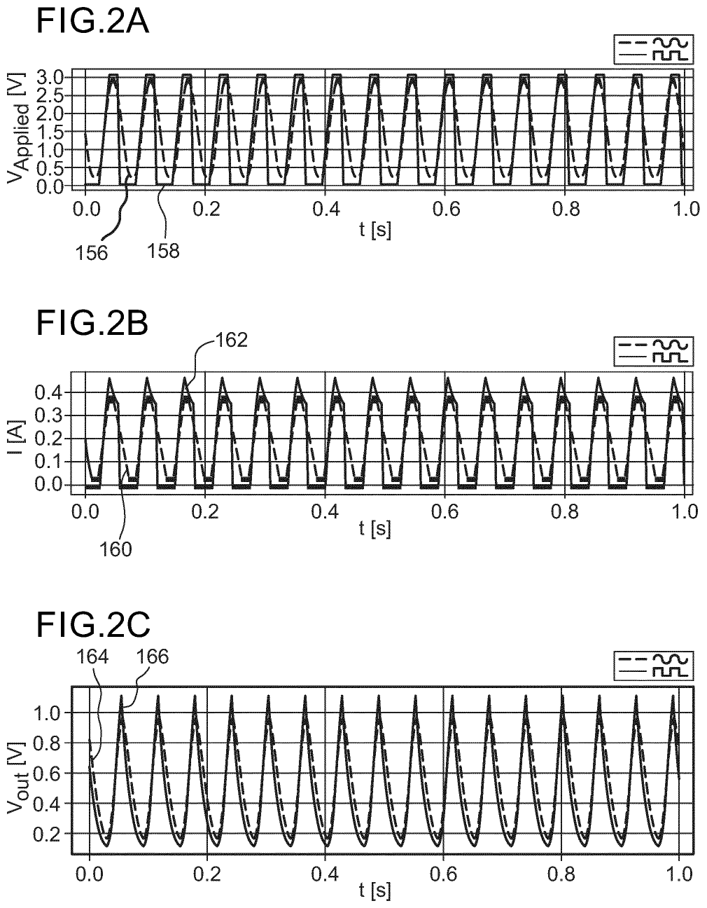

FIGS. 2A-2C show experimental results regarding an exemplary embodiment of the device 110, e.g. as described with respect to FIG. 1. FIG. 2A shows the periodic time-dependent voltage V_{Applied} in V used as input voltage for the incandescent lamp 114 as a function of time in seconds. The frequency of the periodic time-dependent voltage V_{Applied} may be 16 Hz. As comparison in FIG. 2A a square wave voltage is applied to the incandescent lamp 114 at the same frequency, by only turning the buck converter 136 on and off via its enable pin. The periodic time-dependent voltage V_{Applied} is denoted with reference sign 156. The square wave voltage is denoted with reference sign 158. Without any extra measures, the current flowing through the incandescent lamp 114 in the cold state is so high that the life span of the incandescent lamp 114 is reduced to some thousand pulses. Thus, a soft-start measure is taken, which decreases the slope of the rising voltage flank of the square wave as shown in FIG. 2A.

FIG. 2B shows the currents I in A corresponding to the voltages shown in FIG. 2A as a function of time in seconds. The current corresponding to the periodic time-dependent voltage V_{Applied} is denoted with reference sign 160. The current corresponding to the square wave voltage is denoted with reference sign 162. The currents are measured across a shunt with 0.5Ω.

Within the time scale going from 0 to 1 second, the measured currents repeatedly go from approximately 0 up to approximately 0.4 A and back again. The peaks above 0.4 A of the current corresponding to the square wave voltage indicate that there is an overshoot of current flowing through the incandescent lamp 114. Thus, regardless of the soft-start measure of the square wave voltage, an overshoot of current flowing through the incandescent lamp 114 can be seen in FIG. 2B for the square wave voltage. In contrast to the square wave voltage, the sinusoidal voltage V_{applied} leads to a sinusoidal current without current overshoot. Since there is no overshooting of the sinusoidal current through the incandescent lamp 114 even in a cold state, a longer lifetime of the incandescent lamp 114 may be achieved.

To characterize and compare a sinusoidal wave and a square wave, total harmonic distortion (THD) can be used. Without being bound by theory, applying a sinusoidal wave to a non-linear load may cause presence of harmonics and thus, distortion of the waveform. The harmonics may be overtones which are multiples, specifically whole number multiples, of the frequency of the voltage signal. A distorted periodic voltage waveform V(t) may be written as

$$V ( t ) = {V}_{0} + {\sum }_{h = 1}^{∞} {V}_{h} sin ( h ω t + {θ}_{h} )$$

wherein V₀ is a DC component voltage, voltages Vₕ the respective voltage at a harmonic h, t is the time and ω is the frequency and θₕ is the phase angle. The distortion of the waveform can be written as a single quantity/index, denoted as “Total Harmonic Distortion” (THD). THD is a known tool to identify how much of the distortion of a voltage or current is due to harmonics in the signal. A voltage or current that is purely sinusoidal has no harmonic distortion because it is a signal consisting of a single frequency, e.g. 16 Hz which is used in this experiment. A voltage or current that is periodic but not purely sinusoidal will have higher frequency components in it contributing to the harmonic distortion of the signal. In general, the less that a periodic signal looks like a sine wave, the stronger the harmonic components are and the more harmonic distortion it will have.

The electronic circuit 116 is configured for controlling the periodic time-dependent voltage such that a total harmonic distortion of the periodic time-dependent voltage is in a range from 0.01 to 0.2, preferably from 0.015 to 0.15, more preferably from 0.02 to 0.1. The total harmonic distortion THD of the sinusoidal voltage may be calculated as the quotient of the root-mean-square (RMS) values of the applied voltage with all of the harmonics filtered out wherein the total harmonic distortion of the sinusoidal voltage, calculated as the quotient of the RMS values of the applied voltage with all of the harmonics filtered out leaving just the fundamental frequency, denoted as V_{Applied,RMS,Fundemental}, and the RMS value of the applied voltage with the fundamental frequency filtered out leaving all of the harmonics, denoted V_{Applied,RMS without Fundemental}, as

$$THD = \frac{{V}_{Applied , RMS without Fundemental}}{{V}_{Applied , RMS Fundemental}} .$$

In this experiment, the THD of a pure square wave is 48.3%. Since the soft-start measure is taken, a THD of about 40% can be achieved with the suggested buck converter 136. In contrast to the square wave, the sinusoidal wave has a THD of about 5% (a perfect sine would have 0%), which means that a much higher percentage of the energy is transferred over the fundamental harmonic at the desired operation frequency. In power systems, lower THD implies lower peak currents, less heating and lower electromagnetic emissions.

FIG. 2C shows the corresponding optical output Vₒᵤₜ in V of the incandescent lamp 114 as a function of time tin seconds. The optical output corresponding to the sinusoidal voltage V_{Applied} is denoted with reference sign 164. The optical output corresponding to the square wave voltage is denoted with reference sign 166. The optical output of the incandescent lamp 114 is measured using an indium gallium arsenide (InGaAs) detector.

FIG. 2C shows that the overshoot of current corresponding to the square wave voltage leads to a higher temperature and thus a larger dynamic range. Nevertheless, if the optical output is recorded by means of optical detectors and a data processing tools such as fast Fourier transformation (FFT) is used, the amplitude of the frequency component at the fundamental frequency is employed as signal intensity and not the dynamic range of the optical output in time domain. Thus, even though the dynamic range with the square wave is higher, the amplitude of the fundamental frequency component of the sine way may be comparable, as was the case with the experimental results.

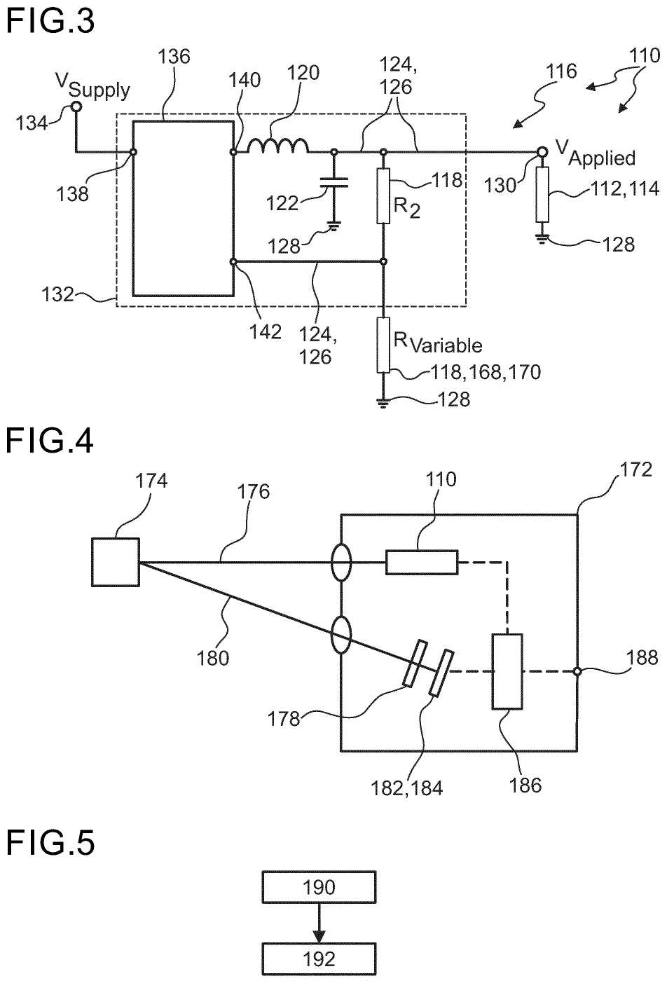

In FIG. 3, a further exemplary embodiment of a device 110 according to the present invention is schematically depicted. For the description of FIG. 3, reference can be made to the description of FIG. 1, wherein in FIG. 3 the variable electronic component 146 may be or may comprise a variable resistor 168.

The variable resistor 168 may be configured for changing its resistance R_{Variable} periodically as a function of time thereby transforming the output of the variable buck regulator 132 into a periodic time-dependent voltage, which may be applied to the radiation emitting element 112 as the applied voltage V_{Applied}. The variable resistor 168 may be a resistor 118 with a variable resistance, specifically a resistance which is continuously variable over time. The variable resistor 168 may be configured to vary its resistance over a continuous resistance range. The variable resistor may be configured to vary its resistance between a plurality of discrete resistance values. The variable resistor may cause a variable voltage drop in the electronic circuit 116. As an example, a constant output voltage of the variable output buck regulator 132 may experience a variable voltage drop over the variable resistor 168 over time resulting in a periodic time-dependent voltage. The variable resistor 168 may be grounded. The variable resistor 168 may be connected in series to at least one further resistor 118 of the resistor network, specifically the resistor R₂, and to the output feedback connection 142 of the buck converter 136.

The variable resistor 168 may comprise a digital potentiometer 170, wherein a potentiometer may be a three-terminal resistor with a sliding or rotating contact forming an adjustable voltage divider. Consequently, the digital potentiometer 170 may be a digitally-controlled electronic component which mimics the analog functions of a potentiometer.

In FIG. 4 an exemplary embodiment of a spectrometer device 172 according to the present invention is schematically depicted. The spectrometer device 172 comprises at least one device 110 according to the present invention, wherein the device 110 is configured for illuminating at least one measurement object 174. The device 110 may emit an illumination light beam 176 for illuminating the measurement object 174. The spectrometer device 172 may be an apparatus which is capable of recording signal intensity with respect to the corresponding wavelength of a spectrum or a partition thereof, such as a wavelength interval, wherein the signal intensity may, preferably, be provided as an electrical signal which may be used for further evaluation. The measurement object 174 may be an object which is to be measured, e.g. for which a spectrum is to be recorded, wherein the object has in principle arbitrary properties, e.g. arbitrary optical properties or an arbitrary shape. The object may be a sample or an arbitrary body, chosen from a living object and a non-living object. Thus, as an example, the at least one object may comprise one or more articles and/or one or more parts of an article, wherein the at least one article or the at least one part thereof may comprise at least one component which may provide a spectrum suitable for investigations. Additionally or alternatively, the object may be or may comprise one or more living beings and/or one or more parts thereof, such as one or more body parts of a human being, e.g. a user, and/or an animal.

The spectrometer device 172 comprises at least one filter element 178. The filter element 178 is configured to separate at least one incident light beam 180 remitted by the measurement object 174 into a spectrum of constituent wavelength. The filter element 178 may be an optical element which is adapted for separating incident light into the spectrum of constituent wavelength signals. For example, the filter element 178 may be or may comprise at least one prism. For example, the filter element 178 may be and/or may comprise at least one optical filter such as a length variable filter, i.e. an optical filter which comprises a plurality of filters, preferably a plurality of interference filters, which may, in particular, be provided in a continuous arrangement of the filters. Herein, each of the filters may form a bandpass with a variable center wavelength for each spatial position on the filter, preferably continuously, along a single dimension, which is, usually, denoted by the term “length”, on a receiving surface of the length variable filter. In a preferred example, the variable center wavelength may be a linear function of the spatial position on the filter, in which case the length variable filter is usually referred to as a “linearly variable filter” or by its abbreviation “LVF”. However, other kinds of functions may be applicable to the relationship between the variable center wavelength and the spatial position on the filter. Herein, the filters may be located on a transparent substrate which may, in particular, comprise at least one material that may show a high degree of optical transparency within in the visual and/or infrared (IR) spectral range, especially, within the near-infrared (NIR) spectral range as described below in more detail, whereby varying spectral properties, especially continuously varying spectral properties, of the filter along length of the filter may be achieved. In particular, the filter element 178 may be a wedge filter that may be adapted to carry at least one response coating on a transparent substrate, wherein the response coating may exhibit a spatially variable property, in particular, a spatially variable thickness. However, other kinds of length variable filters which may comprise other materials or which may exhibit a further spatially variable property may also be feasible. At a normal angle of incidence of an incident light beam 180, each of the filters as comprised by the length variable filter may have a bandpass width that may amount to a fraction of the center wavelength, typically to a few percent, of the particular filter. By way of example, for a length variable filter having a wavelength range from 1400 to 1700 nm and a bandpass width of 1%, the bandpass width at the normal incidence angle might vary from 14 nm to 17 nm. However, other examples may also be feasible. As a result of this particular set-up of the length variable filter, only incident light having a wavelength which may, within a tolerance indicated by the bandpass width, equal the center wavelength being assigned to a particular spatial position on the filter is able to pass through the length variable filter at the particular spatial position. Thus, a “transmitting wavelength” which may be equal to the center wavelength ±½ of the bandpass width may be defined for each spatial position on the length variable filter. In other words, all light which may not pass through the length variable filter at the transmitting wavelength may be absorbed or, mostly, reflected by the receiving surface of the length variable filter. As a result, the length variable filter has a varying transmittance which may enable it for separating the incident light into a spectrum.

The spectrometer device 172 comprises at least one sensor element 182 having a matrix of optical sensors 184. The optical sensors 184 each have a light-sensitive area. Each optical sensor 184 is configured for generating at least one sensor signal in response to an illumination of the light-sensitive area. The optical sensor 184 may be a light-sensitive device for detecting a light beam, such as for detecting an illumination and/or a light spot generated by at least one light beam. The light-sensitive are may be an area of the optical sensor 184 which may be illuminated externally, by the at least one light beam, in response to which illumination at least one sensor signal is generated. The light-sensitive area may specifically be located on a surface of the respective optical sensor 184. Other embodiments, however, are feasible. Singe optical sensors 184 may each have one light sensitive area. One combined optical sensor 184 may have a plurality of light sensitive areas.

The optical sensor 184 may comprise a light-sensitive device configured to generate one output signal. In case the spectrometer device 172 comprises a plurality of optical sensors 184, each optical sensor 184 may be embodied such that precisely one light-sensitive area is present in the respective optical sensor 184, such as by providing precisely one light-sensitive area which may be illuminated, in response to which illumination precisely one uniform sensor signal is created for the whole optical sensor 184. Thus, each optical sensor 184 may be a single area optical sensor 184. The use of the single area optical sensors 184, however, renders the setup of the detector specifically simple and efficient. Thus, as an example, commercially available photo-sensors, such as commercially available silicon photodiodes, each having precisely one sensitive area, may be used in the set-up. Other embodiments, however, are feasible. The optical sensors 184 may be part of or constitute a pixelated optical device. For example, the optical sensor 184 may be and/or may comprise at least one CCD and/or CMOS device. As an example, the optical sensors 184 may be part of or constitute at least one CCD and/or CMOS device having a matrix of pixels, each pixel forming a light-sensitive area.

The optical sensors 184 specifically may be or may comprise at least one photodetector, preferably inorganic photodetectors, more preferably inorganic semiconductor photodetectors, most preferably silicon photodetectors. Specifically, the optical sensors 184 may be sensitive in the infrared spectral range. All pixels of the matrix or at least a group of the optical sensors 184 of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensors 184 may be or may comprise at least one inorganic photodiode which is sensitive in the infrared spectral range, preferably in the range of 700 nm to 3.0 micrometers. Specifically, the optical sensors 184 may be sensitive in the part of the near infrared region where silicon photodiodes are applicable specifically in the range of 700 nm to 1100 nm. Infrared optical sensors which may be used for optical sensors 184 may be commercially available infrared optical sensors, such as infrared optical sensors commercially available under the brand name Hertzstueck™ from trinamiX GmbH, D-67056 Ludwigshafen am Rhein, Germany. Thus, as an example, the optical sensors 184 may comprise at least one optical sensor 184 of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensors 184 may comprise at least one optical sensor 184 of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensors 184 may comprise at least one photoconductive sensor such as a PbS or PbSe sensor, a bolometer, preferably a bolometer selected from the group consisting of a VO bolometer and an amorphous Si bolometer.

The matrix may be composed of independent pixels such as of independent optical sensors 184. Thus, a matrix of inorganic photodiodes may be composed. Alternatively, however, a commercially available matrix may be used, such as one or more of a CCD detector, such as a CCD detector chip, and/or a CMOS detector, such as a CMOS detector chip. Thus, generally, the optical sensor 184 may be and/or may comprise at least one CCD and/or CMOS device and/or the optical sensors 184 of the detector may form a sensor array or may be part of a sensor array, such as the above-mentioned matrix. Thus, as an example, the optical sensors 184 may comprise and/or constitute an array of pixels, such as a rectangular array, having m rows and n columns, with m, n, independently, being positive integers. For example, the sensor element 182 may comprise at least two optical sensors 184 arranged in a row and or column such as a bi-cell. For example, the sensor element 182 may a quadrant diode system comprising a 2×2 matrix of optical sensors 184. For example, more than one column and more than one row is given, i.e. n>1, m>1. Thus, as an example, n may be 2 to 16 or higher and m may be 2 to 16 or higher. Preferably, the ratio of the number of rows and the number of columns is close to 1. As an example, n and m may be selected such that 0.3≤m/n≤3, such as by choosing m/n=1:1, 4:3, 16:9 or similar. As an example, the array may be a square array, having an equal number of rows and columns, such as by choosing m=2, n=2 or m=3, n=3 or the like.

The matrix specifically may be a rectangular matrix having at least one row, preferably a plurality of rows, and a plurality of columns. As an example, the rows and columns may be oriented essentially perpendicular. In order to provide a wide range of view, the matrix specifically may have at least 10 rows, preferably at least 500 rows, more preferably at least 1000 rows. Similarly, the matrix may have at least 10 columns, preferably at least 500 columns, more preferably at least 1000 columns. The matrix may comprise at least 50 optical sensors 184, preferably at least 100000 optical sensors 184, more preferably at least 5000000 optical sensors 184. The matrix may comprise a number of pixels in a multi-mega pixel range. Other embodiments, however, are feasible. Thus, in setups in which an axial rotational symmetry is to be expected, circular arrangements or concentric arrangements of the optical sensors 184 of the matrix, which may also be referred to as pixels, may be preferred.

Preferably, the light sensitive area may be oriented essentially perpendicular to an optical axis of the spectrometer device 172. The optical axis may be a straight optical axis or may be bent or even split, such as by using one or more deflection elements and/or by using one or more beam splitters, wherein the essentially perpendicular orientation, in the latter cases, may refer to the local optical axis in the respective branch or beam path of the optical setup.

The sensor signal may be a signal generated by the optical sensor 184 and/or at least one pixel of the optical sensor 184 in response to illumination. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like.

The spectrometer device 172 comprises at least one evaluation device 186 configured for determining at least one item of information related to the spectrum by evaluating the sensor signals. The evaluation device 186 may be an arbitrary device adapted to perform the named operation, preferably by using at least one data processing device and, more preferably, by using at least one processor and/or at least one application-specific integrated circuit. Thus, as an example, the at least one evaluation device 186 may comprise at least one data processing device having a software code stored thereon comprising a number of computer commands. The evaluation device 186 may provide one or more hardware elements for performing one or more of the named operations and/or may provide one or more processors with software running thereon for performing one or more of the named operations. As an example, the evaluation device 186 may comprise one or more programmable devices such as one or more computers, application-specific integrated circuits (ASICs), Digital Signal Processors (DSPs), or Field Programmable Gate Arrays (FPGAs) which are configured to perform the evaluation. Additionally or alternatively, however, the evaluation device 186 may also fully or partially be embodied by hardware. The at least one item of information may, for example, be provided electronically, visually, acoustically or in any arbitrary combination thereof. Further, the at least one item of information may be stored in a data storage device of the spectrometer device 172 or of a separate storage device and/or may be provided via at least one interface 188, such as a wireless interface and/or a wire-bound interface. The evaluation device 186 may further be connected to the device 110 according to the present invention wirelessly and/or wire-bound.

FIG. 5 shows a flow chart of an embodiment of a method for operation a device 110 comprising at least one radiation emitting element 112 according to the present invention. The method comprises the following steps:
I. (denoted with reference sign 190) applying at least one periodic time-dependent voltage to at least one of the radiation emitting elements;
II. (denoted with reference sign 192) controlling one or more of the amplitude, the duty cycle and the frequency of the periodic time-dependent voltage with at least one of the electronic circuits.

The method steps may be performed in the given order. It shall be noted, however, that a different order is also possible. The method may comprise further method steps which are not listed. Further, one or more of the method steps may be performed once or repeatedly. Further, two or more of the method steps may be performed simultaneously or in a timely overlapping fashion.

### LIST OF REFERENCE NUMBERS

110 Device
112 Radiation emitting element
114 Incandescent lamp
116 Electronic circuit
118 Resistor
120 Inductor
122 Capacitor
124 Wire
126 Trace
128 Ground
130 Voltage source
132 Buck regulator
134 First input voltage source
136 Buck converter
138 Voltage input
140 Inductor connection
142 Output feedback connection
144 Resistor network
R₁ First resistor
R₂ Second resistor
R₃ Third resistor
146 Variable electronic component
148 Variable voltage source
150 Modulated voltage source
152 Second input voltage source
154 Digital-Analog-Converter (DAC)
156 Sinusoidal voltage
158 Square wave voltage
160 Current corresponding to the sinusoidal voltage
162 Current corresponding to the square wave voltage
164 Optical output corresponding to the sinusoidal voltage
166 Optical output corresponding to the square wave voltage
168 Variable resistor
170 Digital potentiometer
172 Spectrometer device
174 Measurement object
176 Illumination light beam
178 Filter element
180 Incident light beam
182 Sensor element
184 Optical sensor
186 Evaluation device
188 Interface
190 Method step I
192 Method step II

1. A device comprising:
a) at least one radiation emitting element configured for emitting a modulated thermal radiation as a result of its temperature; wherein the radiation emitting element comprises at least one incandescent lamp; and
b) at least one electronic circuit configured for applying a periodic time-dependent voltage to the radiation emitting element, wherein the electronic circuit is configured for controlling one or more of an amplitude, a duty cycle and a frequency of the periodic time-dependent voltage, wherein a temperature of the radiation emitting element and a frequency of the modulated thermal radiation depend on the applied periodic time-dependent voltage controlled by the electronic circuit.

2. The device of claim 1, wherein the electronic circuit is configured for controlling the periodic time-dependent voltage such that the applied periodic time-dependent voltage is unipolar and sinusoidal.

3. The device of claim 1, wherein the electronic circuit is configured for controlling the periodic time-dependent voltage such that a total harmonic distortion of the periodic time-dependent voltage is in a range from 0.01 to 0.2.

4. The device of claim 1, wherein the electronic circuit is configured for controlling the periodic time-dependent voltage in such a way that a resulting current through the radiation emitting element is also periodic time-dependent with a total harmonic distortion in a range from 0.01 to 0.2.

5. The device of claim 1, wherein the electronic circuit comprises at least one evaluation unit configured for measuring a current flowing through the radiation emitting element, wherein an information about a current state of the current is used to configure the applied periodic time-dependent voltage.

6. The device of claim 1, wherein the electronic circuit is configured for controlling the periodic time-dependent voltage applied to the radiation emitting element such that a total harmonic distortion of an optical output of the radiation emitting element is in a range from 0.05 to 0.4.

7. The device of claim 1, wherein the electronic circuit comprises at least one variable output buck regulator, wherein the buck regulator comprises at least one resistor network.

8. The device of claim 7, wherein the electronic circuit comprises at least one first input voltage source configured for applying a non-modulated supply voltage V_{Supply} to the buck regulator.

9. The device of claim 7, wherein the electronic circuit comprises at least one variable electronic component configured for modulating an output of the variable buck regulator which is applied to the radiation emitting element as an applied voltage V_{Applied}.

10. The device of claim 9, wherein the variable electronic component comprises at least one variable voltage source, wherein the variable voltage source is configured for applying a periodic time-dependent input voltage V_{Input} to the resistor network thereby transforming the output of the variable buck regulator into a periodical time-dependent voltage, which is applied to the radiation emitting element as the applied voltage V_{Applied}.

11. The device of claim 10, wherein the variable voltage source comprises a Digital-Analog-Converter (DAC).

12. The device of claim 9, wherein the variable electronic component comprises at least one variable resistor, wherein the variable resistor is configured for changing its resistance R_{Variable} periodically as a function of time thereby transforming the output of the variable buck regulator into a periodic time-dependent voltage, which is applied to the radiation emitting element as the applied voltage V_{Applied}.

13. The device of claim 12, wherein the variable resistor comprises a digital potentiometer.

14. A spectrometer device comprising
i) at least one device of claim 1, wherein the device is configured for illuminating at least one measurement object;
ii) at least one filter element configured to separate at least one incident light beam remitted by the measurement object into a spectrum of constituent wavelength;
iii) at least one sensor element having a matrix of optical sensors, the optical sensors each having a light-sensitive area, wherein each optical sensor is configured for generating at least one sensor signal in response to an illumination of the light-sensitive area; and
iv) at least one evaluation device configured for determining at least one item of information related to the spectrum by evaluating the sensor signals.

15. A method for operating a device comprising at least one radiation emitting element configured for emitting a modulated thermal radiation as a result of its temperature; wherein the radiation emitting element comprises at least one incandescent lamp, the method comprising:
I) applying at least one periodic time-dependent voltage to the at least one radiation emitting element; and
II) controlling one or more of an amplitude, a duty cycle, and a frequency of the periodic time-dependent voltage with electronic circuits.

16. A non-transient computer-readable medium including instructions that, when executed by one or more processors, cause the one or more processors to perform the method according to claim 15.

17. A method of using the spectrometer device of claim 14, the method comprising using the spectrometer device for a purpose of use selected from the group consisting of: an infrared detection application; a heat detection application; a thermometer application; a heat-seeking application; a flame-detection application; a fire-detection application; a smoke-detection application; a temperature sensing application; a spectroscopy application; an exhaust gas monitoring application; a combustion process monitoring application; a pollution monitoring application; an industrial process monitoring application; a chemical process monitoring application; a food processing process monitoring application; a water quality monitoring application; an air quality monitoring application; a quality control application; a temperature control application; a motion control application; an exhaust control application; a gas sensing application; a gas analytics application; a motion sensing application; a chemical sensing application; a mobile application; a medical application; a mobile spectroscopy application; and a food analysis application.

18. The device of claim 1, wherein the electronic circuit is configured for controlling the periodic time-dependent voltage such that a total harmonic distortion of the periodic time-dependent voltage is in a range from 0.015 to 0.15.

19. The device of claim 1, wherein the electronic circuit is configured for controlling the periodic time-dependent voltage such that a total harmonic distortion of the periodic time-dependent voltage is in a range from 0.02 to 0.1.

20. The device of claim 1, wherein the electronic circuit is configured for controlling the periodic time-dependent voltage in such a way that a resulting current through the radiation emitting element is also periodic time-dependent with a total harmonic distortion in a range from 0.015 to 0.15.
